(19) United States
(12) Patent Application Publication
(10) Pub. No.: US 2026/0113453 A1
(43) Pub. Date: Apr. 23, 2026

(54) ANALYSIS-BASED ADAPTIVE TEMPORAL RESAMPLING DECISION ALGORITHM FOR MACHINE VISION

(71) Applicant: Alibaba (China) Co., Ltd., Hangzhou (CN)

(72) Inventors: Shurun WANG, Beijing (CN); Yan YE, San Diego, CA (US); Jie CHEN, Beijing (CN); Binzhe LI, Hangzhou (CN)

(21) Appl. No.: 19/328,707

(22) Filed: Sep. 15, 2025

Related U.S. Application Data
(60) Provisional application No. 63/709,583, filed on Oct. 21, 2024.

(51) Int. Cl. H04N 19/132; G06V 10/764; G06V 10/82; G06V 20/40; G06V 20/70; H04N 19/136; H04N 19/172; H04N 19/196

(52) U.S. Cl. CPC H04N 19/132; G06V 20/46; H04N 19/136; H04N 19/172; H04N 19/196; G06V 10/764; G06V 10/82; G06V 20/70

(57) ABSTRACT

A method for decoding a bitstream associated with a video sequence is provided. The method includes: decompressing a bitstream associated with a video sequence; reconstructing one or more frames of the video sequence based on the decompressed bitstream; determining a sequence-level mean intersection of union (MIOU) based on one or more reconstructed frames; obtaining a decision metric according to the sequence-level MIOU to determine a resampling ratio and whether to perform a temporal resampling; and resampling the one or more reconstructed frames based on the decision metric.

### CROSS-REFERENCE TO RELATED APPLICATIONS

This application claims priority to U.S. Provisional Application No. 63/709,583, titled “ANALYSIS-BASED ADAPTIVE TEMPORAL RESAMPLING DECISION ALGORITHM FOR MACHINE VISION,” filed on Oct. 21, 2024, which is hereby incorporated by reference in its entirety.

### TECHNICAL FIELD

The present disclosure generally relates to video processing, and more particularly, to analysis-based adaptive temporal resampling decision algorithm for machine vision.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY

Embodiments of the present disclosure provide analysis-based adaptive temporal resampling decision algorithm for machine vision.

In some embodiments, a method for decoding a bitstream associated with a video sequence is provided. The method includes: decompressing a bitstream associated with a video sequence; reconstructing one or more frames of the video sequence based on the decompressed bitstream; determining a sequence-level mean intersection of union (MIOU) based on one or more reconstructed frames; obtaining a decision metric according to the sequence-level MIOU to determine a resampling ratio and whether to perform a temporal resampling; and resampling the one or more reconstructed frames based on the decision metric.

In some embodiments, a method for encoding a video sequence into a bitstream is provided. The method includes: determining a sequence-level mean intersection of union (MIOU) based on one or more frames of the video sequence; obtaining a decision metric according to the sequence-level MIOU to determine a resampling ratio and whether to perform a temporal resampling; resampling the one or more frames based on the decision metric; and encoding the one or more resampled frames to generate a bitstream.

In some embodiments, a method for transmitting a bitstream is provided. The method includes: receiving a video sequence including one or more frames; encoding the video sequence by: determining a sequence-level mean intersection of union (MIOU) based on the one or more frames of the video sequence; obtaining a decision metric according to the sequence-level MIOU to determine a resampling ratio and whether to perform a temporal resampling; resampling the one or more frames based on the decision metric; and encoding the one or more resampled frames; and signaling a bitstream generated based on the encoding.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an example video sequence, according to some embodiments of the present disclosure.

FIG. 2 illustrates a schematic diagram of an example framework for video compression in a video coding system, according to some embodiments of the present disclosure.

FIG. 3 is a schematic diagram illustrating an example analysis based temporal resampling-based compression framework, according to some embodiments of the present disclosure.

FIG. 4 is a block diagram of an example apparatus for encoding or decoding image data, according to some embodiments of the present disclosure.

FIG. 5 is a flowchart for an example method for decoding a bitstream associated with a video sequence, according to some embodiments of the present disclosure.

FIG. 6 is a flowchart for an example method for encoding a video sequence into a bitstream, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Video compression is a critical technology in the digital media landscape, which is indispensable for the practical and efficient use of video in today's data-driven, connected world. The importance of video coding can be summarized in several aspects, including bandwidth efficiency, storage reduction, content accessibility, enabling technologies and quality preservation. Specifically, for bandwidth efficiency, as video content has high data rates, uncompressed video requires significant bandwidth for transmission. Video coding greatly reduces the size of video files, making it possible to stream high-quality content even over limited bandwidth networks, such as mobile data connections. Regarding storage reduction, with the reduction in file size achieved through video coding, storage requirements for video content are significantly lowered. This makes it feasible to store large amounts of video on servers, personal devices, and in the cloud without exhausting storage capacities. For content accessibility, through efficient compression, video coding enables the widespread distribution and accessibility of video content. Users can download or stream videos quickly and reliably, regardless of geographical location or network quality. For enabling technologies, the advances in video coding have been foundational for modern technologies such as video conferencing, streaming services, digital television, and social media platforms, where video is a primary form of content. For quality preservation, effective video coding techniques strive to maintain the highest possible video quality at the lowest possible bitrates. This preserves the viewing experience while keeping data usage to a minimum, which is especially important for users with data caps or slower internet connections. Motivated by this, video compression is developed in recent decades and attracted the interest from both academia and industry.

The development of video coding standards has been critical in the evolution of digital video, enabling efficient storage, transmission, and compatibility across a wide range of devices and services. Over the years, several major standards have emerged, each building on the successes and learning from the limitations of its predecessors, such as Advanced Video Coding (AVC), High Efficiency Video Coding (HEVC), and Versatile Video Coding (VVC). Since 2003, AVC/H.264 has been one of the most widely adopted video coding standards. Developed by the ITU-T Video Coding Experts Group together with the ISO/IEC Moving Picture Experts Group, AVC improved upon previous standards by using more sophisticated tools for prediction, transformation, and entropy coding. It offered significantly better compression efficiency, which meant that it could deliver good video quality at roughly half the bit rate of its predecessors. AVC's flexibility made it suitable for a broad range of applications, from streaming video and Blu-ray Discs to satellite television and video conferencing. As demand for higher video resolutions and quality continued to grow, there was a need for an even more efficient coding standard. HEVC/H.265, finalized in 2013, addressed this by offering a substantial improvement over AVC in terms of compression efficiency. HEVC was able to provide the same visual quality as AVC with about a 50% reduction in bit rate, making it an ideal choice for 4K and 8K video resolutions. It achieved this improvement by enhancing various coding tools, including more advanced prediction algorithms, larger transformation blocks, improved entropy coding, and better motion vector prediction. VVC is the most recent evolution in the sequence of video coding standards, finalized in 2020. It was developed with the future of video in mind, targeting another 50%-bit rate reduction over HEVC while maintaining the same level of video quality. VVC introduces new tools and techniques, such as improved intra prediction, enhanced motion modelling, and greater parallel processing capabilities, which are particularly relevant for the next generation of high-resolution video content, including VR and 360-degree videos. VVC is designed to be versatile, catering not only to traditional broadcasting and streaming but also to emerging applications that rely on high-fidelity video content.

Motivated by the development of deep learning, deep learning-based video compression has achieved promising compression performance improvement in recent years. Deep learning-based video compression represents a paradigm shift from traditional codec design, which typically involves handcrafted algorithms and heuristics, to methodologies that leverage the capabilities of neural networks to learn data-driven, optimized representations for compression directly from large datasets of images or videos.

Moreover, according to Sandvine's Global Internet Phenomena Report in 2022, video accounts for 65% of all internet traffic, benefitting from the rich information of video data. In the meanwhile, due to the large data volume of video, video compression is indispensable to facilitate the real-time video transmission in various applications, such as live broadcast and video conference. With the development of computer vision, machine vision is replacing human vision in multiple new application scenarios, such as intelligent traffic and smart city, for the analysing and understanding of video data. Motivated by this, the efficient video compression towards machine vision (VCM) is highly desired.

Based on the development of video compression, in this section, the background is organized as following: the introduction of traditional video codec, the development of deep learning-based video compression and video compression for machine vision.

Traditional hybrid video codecs represent the foundational architecture for most video compression standards used today. These codecs combine spatial and temporal compression techniques to reduce the size of video data significantly while maintaining a balance between compression efficiency and visual quality. The term “hybrid” refers to the use of both inter-frame (temporal) and intra-frame (spatial) coding methods within the codec. Hybrid video codecs have been the backbone of video compression standards from advanced standards like H.264/AVC (used for Blu-ray, streaming, and broadcast), HEVC/H.265 (used for high-resolution videos) and VVC/H.266 (used for 2K and beyond). Each generation of codec has introduced improvements in the efficiency of these core components, allowing for higher-quality video at lower bit rates. However, the basic principles of hybrid coding remain central to the operation of these codecs.

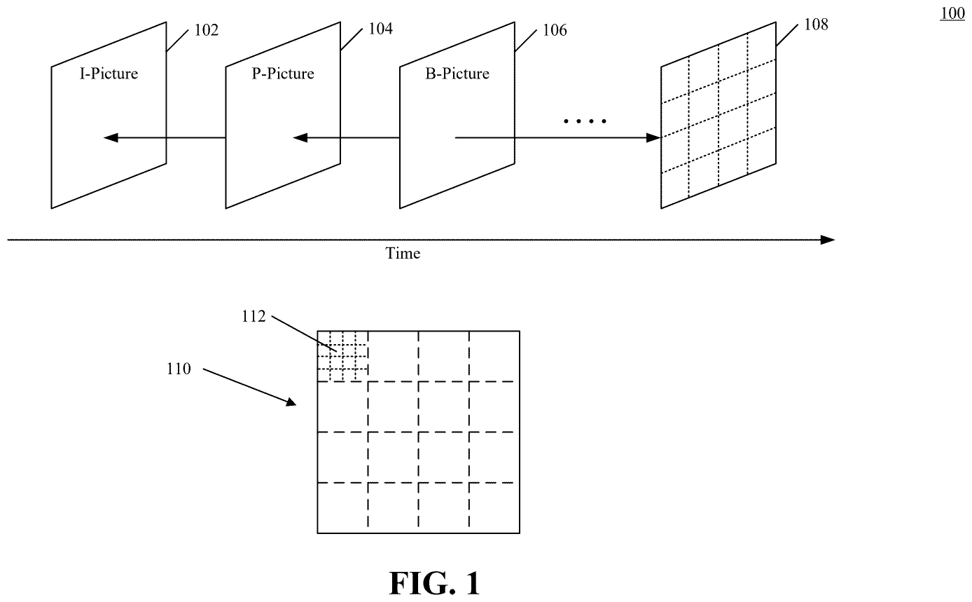

FIG. 1 illustrates structures of an example video sequence, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider. As shown in FIG. 1, video sequence 100 can include a series of pictures arranged temporally along a timeline, including pictures 102, 104, 106, and 108. Pictures 102-106 are continuous, and there are more pictures between pictures 106 and 108.

When a video is being compressed or decompressed, useful information of a picture being encoded (referred to as a “current picture”) include changes with respect to a reference picture (e.g., a picture previously encoded and reconstructed). Such changes can include position changes, luminosity changes, or color changes of the pixels. For example, position changes of a group of pixels can reflect the motion of an object represented by these pixels between two pictures (e.g., the reference picture and the current picture).

For example, as shown in FIG. 1, picture 102 is an I-picture, using itself as the reference picture. Picture 104 is a P-picture, using picture 102 as its reference picture, as indicated by the arrow. Picture 106 is a B-picture, using pictures 104 and 108 as its reference pictures, as indicated by the arrows. In some embodiments, the reference picture of a picture may be or may not be immediately preceding or following the picture. For example, the reference picture of picture 104 can be a picture preceding picture 102, i.e., a picture not immediately preceding picture 104. The above-described reference pictures of pictures 102-106 shown in FIG. 1 are merely examples and not meant to limit the present disclosure.

Due to the computing complexity, in some embodiments, video codecs can split a picture into multiple basic segments and encode or decode the picture segment by segment. That is, video codecs do not necessarily encode or decode an entire picture at one time. Such basic segments are referred to as basic processing units (“BPUs”) in the present disclosure. For example, FIG. 1 also shows an example structure 110 of a picture of video sequence 100 (e.g., any of pictures 102-108). For example, structure 110 may be used to divide picture 108. As shown in FIG. 1, picture 108 is divided into 4×4 basic processing units. In some embodiments, the basic processing units can be referred to as “coding tree units” (“CTUs”) in some video coding standards (e.g., AVS3, H.265/HEVC or H.266/VVC), or as “macroblocks” in some video coding standards (e.g., MPEG family, H.261, H.263, or H.264/AVC). In AVS3 or VVC, a coded tree unit (CTU) can be the largest block unit and can be as large as 128×128 luma samples (plus the corresponding chroma samples depending on the chroma format).

The basic processing units in FIG. 1 are for illustrative purpose only. The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards. Operations performed to a basic processing unit can be repeatedly performed to its luma and chroma components.

During multiple stages of operations in video coding, the size of the basic processing units may still be too large for processing, and thus can be further partitioned into segments referred to as “basic processing sub-units” in the present disclosure. For example, at a mode decision stage, the encoder can split the basic processing unit into multiple basic processing sub-units and decide a prediction type for each individual basic processing sub-unit. As shown in FIG. 1, basic processing unit 112 in structure 110 is further partitioned into 4×4 basic processing sub-units. For example, a coded tree unit CTU may be further partitioned into coding units (CUs) using quad-tree, binary tree, or extended binary tree. The basic processing sub-units in FIG. 1 is for illustrative purpose only. Different basic processing units of the same picture can be partitioned into basic processing sub-units in different schemes. The basic processing sub-units can be referred to as “coding units” (“CUs”) in some video coding standards (e.g., AVS3, H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Operations performed to a basic processing sub-unit can be repeatedly performed to its luma and chroma components. Such division can be performed to further levels depending on processing needs, and in different stages, the basic processing units can be partitioned using different schemes. At the leaf nodes of the partitioning structure, coding information such as coding mode (e.g., intra prediction mode or inter prediction mode), motion information (e.g., reference index, motion vectors (MVs), etc.) required for corresponding coding mode, and quantized residual coefficients are sent.

In some cases, a basic processing sub-unit can still be too large to process in some stages of operations in video coding, such as a prediction stage or a transform stage. Accordingly, the encoder can further split the basic processing sub-unit into smaller segments (e.g., referred to as “prediction blocks” or “PBs”), at the level of which a prediction operation can be performed. Similarly, the encoder can further split the basic processing sub-unit into smaller segments (e.g., referred to as “transform blocks” or “TBs”), at the level of which a transform operation can be performed. The division schemes of the same basic processing sub-unit can be different at the prediction stage and the transform stage. For example, the prediction blocks (PBs) and transform blocks (TBs) of the same CU can have different sizes and numbers.

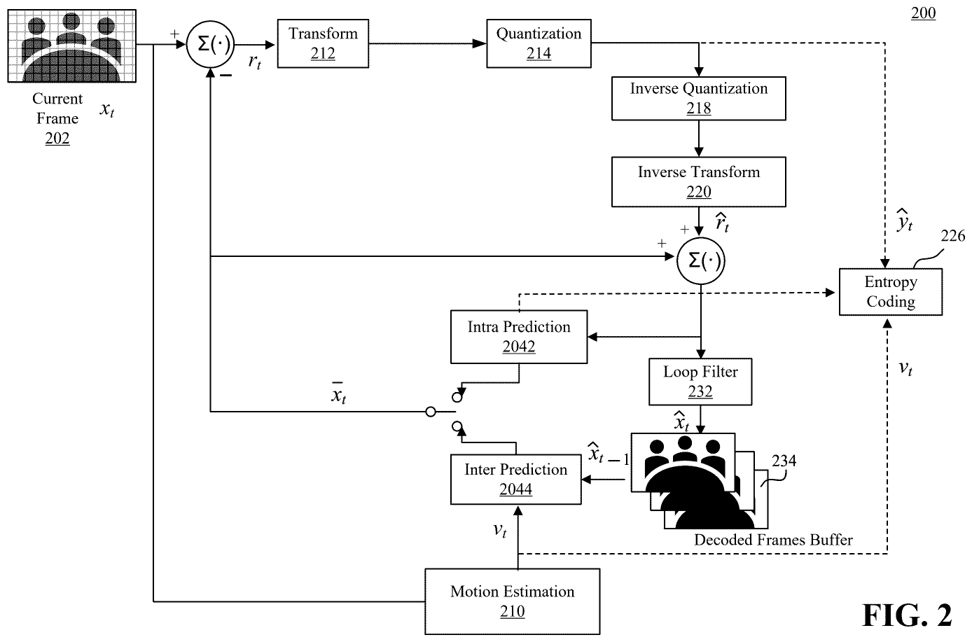

FIG. 2 illustrates a schematic diagram of an example framework 200 for video compression in a video coding system, according to some embodiments of the present disclosure. Generally, the video compression encoder generates the bitstream based on the input current frames. And the decoder reconstructs the video frames based on the received bitstreams. The framework 200 in FIG. 2 follows the predict-transform architecture.

In some embodiments, a hybrid video codec includes the following key components that work together in a sequential pipeline, as shown in FIG. 2.

The input video is processed block by block. Specifically, the input frame xₜ (e.g., a current frame 202) is split into a set of blocks, e.g., square regions, of the same size (e.g., 8×8). The encoding procedure of the video compression algorithm in the encoder side will be discussed as follows.

The motion estimation and compensation operations are performed in the encoding procedure. The input frame xₜ is processed by a block-based motion estimation module 210 configured to estimate the motion between the current frame xₜ and a previous reconstructed frame \hat{x}ₜ₋₁. Based on the input frame xₜ and the previous reconstructed frame \hat{x}ₜ₋₁, the block-based motion estimation module 210 outputs a corresponding motion vector vₜ for each block. The motion estimation is a crucial part of inter-frame compression. The codec estimates the motion that occurs between frames and encodes this motion using motion vectors. These vectors are used during decoding to shift blocks of pixels from a reference frame (I or P) to predict the current frame, reducing the need to encode the entire frame from scratch.

Then, the inter-frame (temporal) compression operations can be performed in the encoding procedure. The corresponding motion vector vₜ is processed by an inter prediction module 2044 in order to obtain a predicted frame x̅ₜ by copying the corresponding pixels in the previous reconstructed frame \hat{x}ₜ₋₁, to the current frame based on the motion vector vₜ defined in the motion estimation module 210. Accordingly, a residual rₜ between the original frame xₜ and the predicted frame x̅ₜ is obtained as rₜ=xₜ−x̅ₜ. In some embodiments, the motion compensated prediction performed above is also known as an “inter prediction,” “inter-picture prediction,” or “temporal prediction.” The inter-frame coding capitalizes on the redundancies between successive frames. In some embodiments, only the first frame in a sequence, called an I-frame or keyframe, is encoded using intra-frame coding. Subsequent frames, known as P-frames (predictive) or B-frames (bi-directional predictive), are encoded using only the differences from previous or future frames. As described above, the motion estimation is used to find matching blocks in reference frames, and motion vectors are generated for describing how those blocks move from one frame to the next. The differences, or residuals, along with the motion vectors, can then be encoded.

The intra-frame (spatial) compression operations are also performed in the encoding procedure. The first step in the encoding process typically involves intra-frame coding, which compresses each frame as a standalone image. For example, at intra prediction stage 2042, the encoder can perform the intra prediction. It uses spatial redundancy within the frame to reduce the amount of data. Techniques such as transform coding (e.g., Discrete Cosine Transform, DCT) and quantization are employed to convert the spatial pixel values into a frequency domain where they can be more efficiently coded. The result is a set of coefficients that can be further compressed using entropy coding techniques like Huffman or arithmetic coding. In addition to the above, some intra-frame compression techniques employ predictive coding to reduce redundancy. Predictive coding works by estimating pixel values based on neighboring pixels and encoding only the difference between the actual value and the prediction. This approach can be particularly effective for reducing spatial redundancy in smooth or slowly varying image regions.

As shown in FIG. 2, after the residual rₜ is generated, the encoder can feed the residual rₜ to a transform stage 212 and a quantization stage 214 to generate quantized result ŷₜ. In some embodiments, a linear transform (e.g., DCT) can be used before the quantization for better compression performance. Different transform algorithms can use different base patterns. Various transform algorithms can be used at transform stage 212, such as, for example, a discrete cosine transform, a discrete sine transform, or the like. The transformation at transform stage 212 is invertible. That is, the encoder can restore the residual rₜ by an inverse operation of the transform (referred to as an “inverse transform”) performed by an inverse transform stage 220. For a video coding standard, the encoder and a corresponding decoder can use the same transform algorithm (thus the same base patterns). Thus, the encoder can record only the transform coefficients, from which a decoder can reconstruct the residual rₜ without receiving the base patterns from the encoder.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized residual coefficients ŷₜ by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized residual coefficients ŷₜ, by which the transform coefficients are further compressed. The quantization process is also invertible, in which quantized residual coefficients ŷₜ can be reconstructed to the transform coefficients in an inverse operation of the quantization (referred to as “inverse quantization”) performed by an inverse quantization stage 218.

Because the encoder disregards the remainders of such divisions in the rounding operation, the quantization stage 214 can be lossy. Typically, quantization stage 214 can contribute the most information loss in the encoding process. The larger the information loss is, the fewer bits the quantized residual coefficients ŷₜ can need. For obtaining different levels of information loss, the encoder can use different values of the quantization parameter or any other parameter of the quantization process.

The entropy coding operations are performed in the encoding procedure. In some embodiments, the codec employs entropy coding to further compress the video data by encoding the symbols (quantized coefficients, motion vectors, and other side information) based on their statistical distribution. The more frequent a symbol, the shorter the code assigned to it, which ensures that the overall bit rate is minimized. As shown in FIG. 2, the encoder can feed the motion vector vₜ and quantized residual coefficients ŷₜ to a coding module 226 to generate the bitstream to complete a forward path. By the coding module 226, the encoder can encode the motion vector vₜ and quantized residual coefficients ŷₜ using a binary coding technique, such as, for example, entropy coding, variable length coding, arithmetic coding, Huffman coding, context-adaptive binary arithmetic coding (CABAC), or any other lossless or lossy compression algorithm. Accordingly, the motion vector vₜ and the quantized residual coefficients ŷₜ can be encoded into bits by an entropy coding method and sent to the decoder.

As explained above, by the inverse transform module 240, the quantized result ŷₜ can be used for obtaining the reconstructed residual \hat{r}ₜ by the inverse transform. During the process, after quantization stage 214, the encoder can feed quantized residual coefficients ŷₜ to the inverse quantization stage 218 and the inverse transform stage 220 to generate reconstructed residual \hat{r}ₜ. At the inverse quantization stage 218, the encoder can perform inverse quantization on quantized residual coefficients ŷₜ to generate reconstructed transform coefficients. At the inverse transform stage, the encoder can generate the reconstructed residual \hat{r}ₜ based on the reconstructed transform coefficients. Then, the encoder can add the reconstructed residual \hat{r}ₜ to the predicted frame x̅ₜ to obtain the reconstructed frame \hat{x}ₜ to be used for the next iteration of process, i.e., \hat{x}ₜ=\hat{r}ₜ+x̅ₜ. The reconstructed frame \hat{x}ₜ will be used by the (t+1)ₜₕ frame in the motion estimation module 210 for the motion estimation.

After prediction and reconstruction, there might still be artifacts in the video, such as blocking effects due to quantization. Loop filters like deblocking filters are applied to the reconstructed frames within the codec processing loop to smooth out these artifacts and improve visual quality. For example, in some embodiments, after generating the reconstructed frame \hat{x}ₜ, the encoder can apply a loop filter stage 232 to the reconstructed frame \hat{x}ₜ to reduce or eliminate distortion (e.g., blocking artifacts) introduced by the inter prediction. In some embodiments, the encoder can apply various loop filter techniques at the loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in a decoded frames buffer 234 for later use (e.g., to be used as an inter-prediction reference frame for a future frame of the video sequence). The encoder can store one or more reference frames in the buffer 234 to be used for the inter prediction module 2044. In some embodiments, the encoder can encode parameters of the loop filter (e.g., a loop filter strength) at the coding stage, along with the motion vector vₜ and quantized residual coefficients ŷₜ, and other information. The encoder can perform the process discussed above iteratively to encode each frame of the video sequence.

For the decoder, based on the bits provided by the coding module 226 in the encoder, corresponding motion compensation, inverse transform, and frame reconstruction operations can be performed to obtain the reconstructed frame \hat{x}ₜ.

To further improve the coding performance, numerous algorithms have been developed for future video compression standards, including matrix weighted intra prediction, quadtree plus binary tree, extended coding unit partitioning, affine motion prediction, decoder-side motion vector refinement and mode-dependent non-separable secondary transform. Regarding encoder optimization, various optimization algorithms have also been developed for different targets, including rate-distortion optimization for both signal and feature quality. For surveillance video data, which has been regarded as the largest big data, the concept of golden frames has been introduced for providing better reference quality, and based on this philosophy, background modeling-based surveillance video compression techniques have been developed. Moreover, along with the development of cloud computing, a cloud database has been introduced in image compression as an external reference to further remove the redundancy. In addition, efforts have been devoted to analyzing the bitstream without complete decoding due to the abundant information implied in the bitstream. Scalable compression has become more important in various applications, such as video streaming. Scalable extensions have been proposed for various compression standards, including the scalable extension to H.264/MPEG-4 part 10 AVC (H.264/AVC) and the scalable extension of H.265/HEVC, which are denoted as scalable video coding (SVC) and scalable high-efficiency video coding (SHVC), respectively. The scalable extensions support video scalability in terms of temporal resolution, spatial resolution and quality. Moreover, SHVC supports the scalability of the bit depth and color gamut to fit the deployment of ultrahigh-definition (UHD) video.

Traditional hybrid codecs have been pivotal in the proliferation of digital video, addressing the dual challenges of limited bandwidth and storage with remarkable efficiency.

The development of deep learning-based video compression is a rapidly advancing area of research that seeks to leverage the powerful capabilities of neural networks to revolutionize the way video is compressed and decompressed. Traditional video compression techniques, based on handcrafted algorithms and standards, have been highly successful but are reaching the limits of their efficiency, especially with the ever-increasing video resolutions and frame rates. Deep learning-based methods offer a new avenue for gains in compression by learning optimal representations and compression strategies directly from the data.

The initial foray into deep learning-based video compression began as an exploration of how machine learning, particularly neural networks, could be applied to improve upon the limitations of traditional codec architectures. Researchers started experimenting with various components of the video compression pipeline, seeking to understand where neural networks could fit and how they could enhance the overall process. The first experiments in this domain involved replacing specific components of existing codecs with neural network-based alternatives. For instance, one of the earliest applications was in predictive coding, where neural networks were trained to predict pixel values more accurately than traditional linear models. Another area of exploration was the use of neural networks for improved motion estimation and compensation, which are central to inter-frame compression in traditional codecs. Developers of deep learning-based codecs also focused on intra-frame compression. Convolutional neural networks (CNNs) were particularly suited for this task due to their ability to capture spatial hierarchies in image data. CNNs were trained to transform an image into a compact set of feature maps, which were then quantized and entropy-coded, similar to the process in traditional codecs. However, unlike handcrafted transformations such as DCT, the neural networks could learn transformations that were specifically tailored to the characteristics of the video content. Entropy coding also attracts the interest from both academia and industry, which is a lossless compression step that aims to minimize the number of bits needed to represent the data. Researchers started to explore how neural networks could optimize entropy coding by learning the probability distributions of the data more effectively. Techniques such as autoencoders and recurrent neural networks (RNNs) were utilized to model and encode the data in a more compact form than traditional entropy coding methods like Huffman coding or arithmetic coding. With the advent of deep learning, the idea of in-loop filtering has been reimagined, leading to the development of deep learning-based in-loop filters that can learn to perform this task more effectively. Neural networks are trained to reduce artifacts such as blocking, banding, and blurring that arise due to quantization and other lossy compression processes. Unlike static filters, deep learning-based filters can adapt to the content and characteristics of the video, potentially offering improved reconstruction quality and compression efficiency.

Except for the integrations of deep learning techniques within the traditional hybrid video codecs, the video compression efficiency is further explored in terms of the deep learning based end-to-end structure and optimization. End-to-end learning for video compression represents an innovative approach where the entire compression pipeline is conceptualized, designed, and optimized as a complete system using deep learning techniques. This holistic perspective contrasts with traditional methods, which are composed of distinct modules, each engineered to perform specific tasks like motion estimation, transformation, or entropy coding. With end-to-end learning, neural networks are trained to handle all these functions in a unified framework, potentially discovering more efficient and effective strategies for video compression through direct optimization of a loss function that captures the desired trade-off between compression rate and video quality.

A vanguard work that applied a recurrent neural network (RNN) to end-to-end learned image representation achieves comparable performance compared with JPEG. Researchers proposed a block transform-based image compression model that outperforms JPEG at low bit rates based on the combination of discrete cosine transform (DCT) and convolutional neural network (CNN) models. Generalized divisive normalization (GDN)-based image coding was proposed with a density estimation model and achieves obvious compression performance promotion compared with JPEG 2000. Based on this method, the redundancy can be further eliminated with a variational hyperprior model, which surpasses BPG in terms of rate-distortion performance. The deep video compression (DVC) approach based on an end-to-end model has also achieved better performance compared with H.264/AVC. Generally speaking, the deep learning image compression (DLIC) optimizes the parameters of the encoder and decoder with specific rate-distortion (R-D) tradeoff. In order to explore the generalization of DLIC across various R-D tradeoffs and reduce the memory requirement of storing model parameters, various methods have been proposed for the variable bitrate DLIC. Specifically, a conditional autoencoder was designed in terms of Lagrange multiplier and quantization bin size. A gain unit was proposed to achieve a continuously variable rate in a single model. A channel-wise attention module was introduced to further exploit the bitrate variability. Moreover, a learned variable-rate multi-frequency image compression algorithm was presented, based on the proposed modulated generalized octave convolution (GoConv) and octave transposed-convolution (GoTConv). The proposed scheme can achieve similar performance with HEVC in terms of YUV PSNR and obvious improvement compared with VVC in terms of Y MS-SSIM, in large bitrate range with only three models. The variable-rate video compression scheme was also proposed with a deeply modulated auto-encoder, achieving continuous variable bitrate with almost same compression efficiency as multiple fixed-rate models.

Video coding for machine vision refers to the optimization of video compression techniques specifically for consumption by machine vision systems rather than human viewers. Machine vision systems are used in a variety of applications such as autonomous vehicles, robotics, industrial automation, and surveillance, where it is crucial for the algorithm to detect, classify, and make decisions based on video input. The requirements of machine vision systems can be quite different from those of human viewers, which has led to the development of specialized video coding techniques to meet these unique needs. video coding for machine vision seeks to modify and optimize traditional video compression techniques to suit the needs of automated analysis systems. The focus is on preserving the features that are important for machine interpretation, maintaining low latency, ensuring robustness against environmental conditions, and achieving efficient compression to reduce storage and bandwidth usage.

In recent years, there are various algorithms proposed to improve the compression efficiency of VCM, which mainly focus on the core component of codec (denoted as core codec), i.e., transforming the visual signal to the bitstream. Generally speaking, the core codec can be classified into the codec with hybrid coding framework and the deep learning-based codec, which have been investigated for machine vision in recent years. In hybrid coding framework for image codec, the quantization model can be improved in terms of rate-accuracy performance. Similarly, various algorithms have been proposed to improve machine vision-oriented compression performance of video codecs from the perspective of QP decision model for HEVC and VVC. Moreover, a bitwise efficiency method was proposed in to improve the coding performance of VSCM by truncating the bit depth of luma sample values, motivated by the low sensitivity of bit depth for machine vision tasks.

For deep learning-based codec, the machine vision task losses, image distortion losses and rate loss are combined for the optimization of end-to-end compression model, which outperforms VVC significantly on object detection and instance segmentation tasks. Based on this, the compression performance is improved by optimizing the encoder of the pre-trained codec with online fine-tuning. A latent space masking network (LSMnet) was proposed to mask out the latent space elements, which are presumably not important for instance segmentation task. The redundancy is reduced with a saliency-driven hierarchical neural network image compression model, and the saliency information is extracted with an object detection network. Moreover, an end-to-end image compression is designed for multiple machine tasks. to enable the transformation of the compressed content, from the primary task (object detection) to the secondary task (classification). Motivated by the representation capability of deep learning features for machine analysis, a learning-based codec was proposed, which can compress the extracted machine analysis features and reconstruct the visual signal from the decoded analysis feature. The distortion of joint loss functions for learning based compression models mainly consists of two parts, the signal level fidelity and the machine vision losses, where the weight between the two parts are set empirically, limiting the compression efficiency. To tackle this problem, a general rate-accuracy optimization algorithm was proposed, achieving superior performance than various empirical settings. The joint optimization of the end-to-end compression model and the task model was investigated, achieving superior object detection performance than the HVS oriented end-to-end compression model. Moreover, a unified optimization framework was proposed with variable bitrate modules for both codec and machine analysis model. The machine vision-oriented learning-based video compression is also investigated. An end-to-end video compression framework was developed with a combination of variable-rate intra coding and scale space flow based inter coding. Learned image codec was proposed for intra frame coding and combined with VVC for inter frame coding, denoted as NNVVC. Compared with VVC, NNVVC achieves 51.76% and 38.07% BD-rate savings for instance segmentation task on Open Images dataset and TVD dataset, respectively.

Temporal resampling is an important solution to improve video compression efficiency, motivated by the high temporal redundancy of video data. For temporal resampling towards human vision, a frame rate dependent quality metric (FRQM) can be selected as a metric for temporal resampling decision, by comparing with a predefined threshold. Generally speaking, temporal downsampling is performed as a pre-processing method at the encoder side, by discarding frames to save coding expense. At the decoder side, in order to improve the reconstruction quality, various temporal upsampling algorithms have been proposed. Motion compensation based temporal upsampling was investigated. With the development of optical flow, various optical flow based temporal interpolation methods have been proposed. However, all these methods are designed for human perception. Targeting to improve the coding efficiency of temporal resampling towards machine vision, a frame interpolation model can be optimized for object detection. However, the temporal complexity of various video content could be diverse, indicating that temporal resampling should be performed adaptively in terms of video content, for better robustness and coding efficiency. Currently, the adaptive algorithm of video temporal resampling for machine vision has not been fully investigated.

Embodiments are proposed in the present disclosure to perform analysis-based adaptive temporal resampling decision algorithm for machine vision to further improve the robustness and coding efficiency.

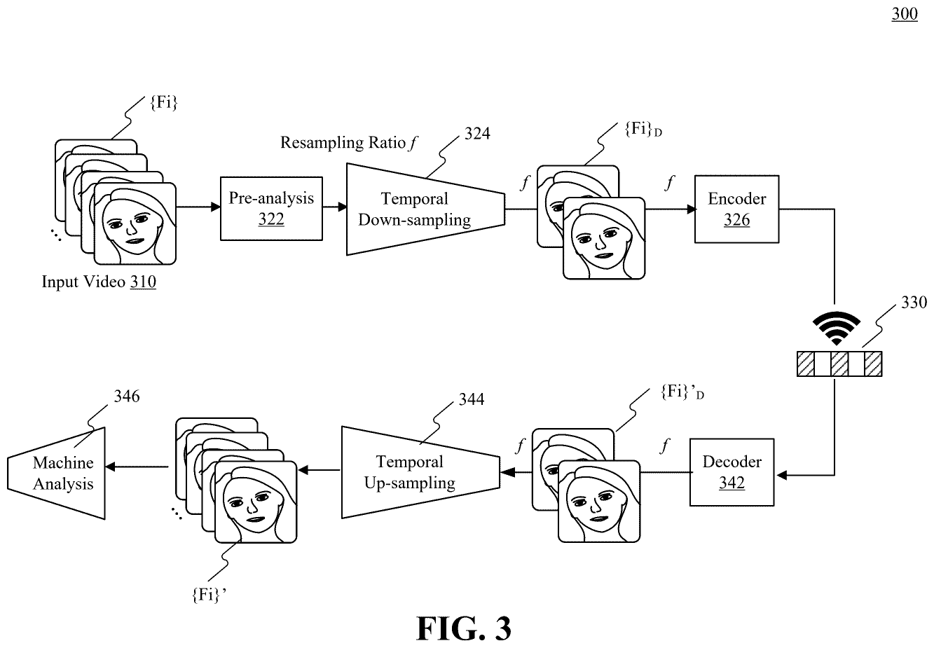

FIG. 3 is a schematic diagram illustrating an example analysis based temporal resampling-based compression framework 300, according to some embodiments of the present disclosure.

As shown in the general temporal resampling-based compression framework 300 in FIG. 3, the input video data {Fᵢ} of an input video 310 can be first processed by a pre-analysis model 322 and then can be rescaled by a temporal down-sampling model 324 based on the resampling ratio f at the encoder side. Accordingly, the output, downsampled data {Fᵢ}_{D}, can be compressed by the encoder 326 to generate the bitstream 330. At the decoder side, the decoder 342 is configured to receive and decode the bitstream 330 to obtain the decompressed data {Fᵢ}_{D}′. The decompressed data {Fᵢ}_{D}′ can be rescaled by a temporal up-sampling model 344 at the decoder side, to obtain the reconstructed video data {Fᵢ}′ as the output of temporal upsampling, based on the resampling ratio f transmitted along with the bitstream 330. In some embodiments, the reconstructed video data {Fᵢ}′ can be sent to a machine analysis model 346 to for further machine vision processing.

Various video frame interpolation methods could be selected for temporal up-sampling. For example, in some embodiments, a simple duplicate method can be selected, by repeating the nearest decoded frame for temporal up-sampling. In some embodiments, the resampling ratio f can be determined by the pre-analysis model 322.

Due to the diversity of video data content, a strategy for determining the appropriate temporal-resampling ratio is a key challenge. An adaptive strategy is needed to adaptively decide whether temporal resampling should be applied, and if so, at what ratio. However, the development of the adaptive temporal resampling decision algorithm has not been fully investigated and explored.

Embodiments are proposed in the present disclosure to describe an analysis-based adaptive temporal resampling decision algorithm for machine vision.

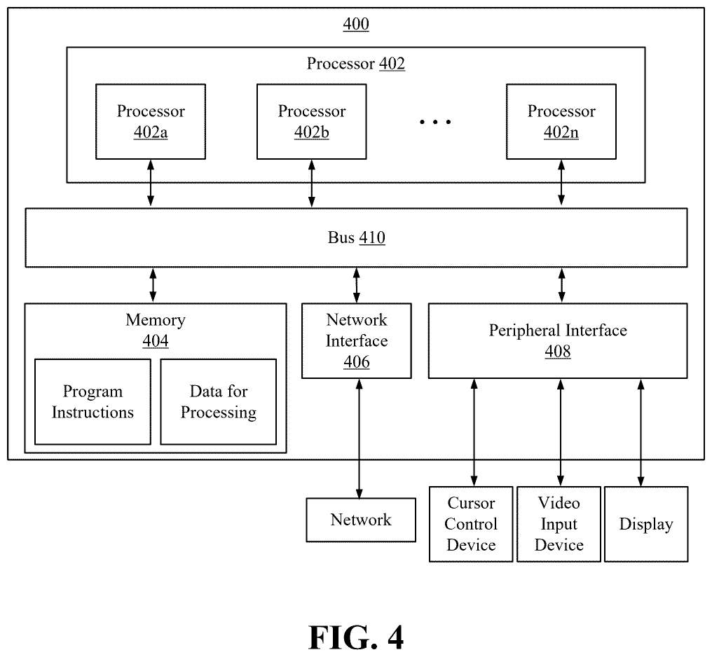

FIG. 4 is a block diagram of an example apparatus 400 for encoding or decoding image data, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes in the framework 200 or the framework 300) and data for processing (e.g., video sequence, video bitstream, or video stream). Processor 402 can access the program instructions and data for processing (e.g., via bus 410) and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processors 402a-402n and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process in the framework 200 or the framework 300) can be implemented as any combination of any software or hardware modules in apparatus 400. For example, some or all stages of process in the framework 200 or the framework 300 can be implemented as one or more software modules of apparatus 400, such as program instructions that can be loaded into memory 404. For another example, some or all stages of process in the framework 200 or the framework 300 can be implemented as one or more hardware modules of apparatus 400, such as a specialized data processing circuit (e.g., an FPGA, an ASIC, an NPU, or the like).

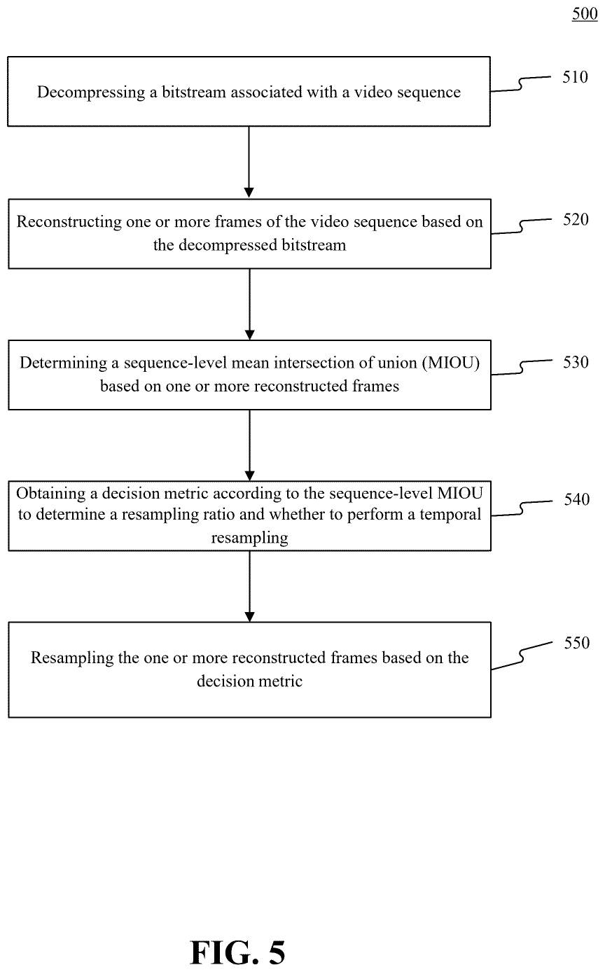

FIG. 5 is a flowchart for an example method 500 for decoding a bitstream associated with a video sequence, according to some embodiments of the present disclosure. The method 500 can be performed by a decoder to decode a video bitstream. For example, the decoder can be implemented as one or more software or hardware components of an apparatus (e.g., apparatus 400 in FIG. 4) for decoding the bitstream (e.g., bitstream 330 in FIG. 3) to reconstruct a video frame or a video sequence of the bitstream. For example, a processor (e.g., processor 402 in FIG. 4) can perform the method 500. As shown in FIG. 5, the method 500 includes the following steps 510-550.

At step 510, the decoder receives and decompresses a bitstream (e.g., bitstream 330 in FIG. 3) associated with a video sequence. At step 520, the decoder reconstructs one or more frames (e.g., the decompressed data {Fᵢ}_{D}′ in FIG. 3) of the video sequence based on the decompressed bitstream.

At step 530, the decoder determines a sequence-level mean intersection of union (MIOU) Mₛ based on one or more reconstructed frames. Generally speaking, temporal resampling can effectively improve the video coding efficiency when the video has low temporal complexity. From a machine vision perspective, the temporal complexity can be evaluated by the level of overlapping objects between different frames. In some embodiments, mean intersection of union (MIOU) Mₛ, is a sequence-level metric defined and used to determine the temporal resampling ratio. The sequence level MIOU Mₛ is based on the MIOU between two frames, noted as frame-level MIOU M_{f}. In other words, MIOU can be calculated at both frame and sequence levels, with methods varying for coding configurations. For example, for various coding configurations, such as random access (RA), low delay (LD) and all intra (AI), the calculation methods of sequence level MIOU Mₛ can be different, to accommodate with the reference dependency and better assess the temporal complexity.

In some embodiments, at step 530, the decoder calculates multiple frame-level MIOUs M_{f} for frame pairs, in which each frame pair includes two frames of the video sequence, and calculates the sequence-level MIOU Mₛ based on the frame-level MIOUs M_{f}. In the following paragraphs, the frame-level MIOU M_{f} will be first defined. Then, the sequence-level MIOU Mₛ under various configurations is further defined. Finally, an adaptive algorithm for determining the temporal resampling ratio is illustrated.

For calculating a frame-level MIOU, given two frames of a video sequence and an object detection model, the object detection can be conducted on the two frames. The detection results of each frame can be noted as B₁={(x_{1,i},y_{1,i},w_{1,i},h_{1,i},c_{1,i},s_{1,i})} and B₂={(x_{2,i},y_{2,i},w_{2,i},h_{2,i},c_{2,i},s_{2,i})} respectively, where the bounding boxes are listed in descending order of the confidence score s. Herein, x and y are the coordinates of the top-left point for the detected bounding box, w and h are the width and height of the detected bounding box, c is the class index of the bounding box, and s is the confidence score in range from 0 to 1.

In some embodiments, the matched pairs of bounding boxes between two frames are first obtained. For example, various methods can be used to pair the detected bounding boxes between two frames, such as greedy algorithm, Kuhn-Munkres algorithm and template matching algorithm. Taking a greedy algorithm as an example, specifically, for every instance in B₁, the intersection of union (IOU, noted as iou) with every instance in B₂, which is in the same class, can be calculated. The instance with the largest IOU (where IOU must be larger than 0) in B₂ can be selected as the matched result of the instance in B₁. After a pair of bounding boxes is found, the paired bounding boxes in B₁ and B₂ are excluded from further matching process, in order to achieve a bijective mapping. As such, the matched results of B₁ and B₂ can be represented as P={(x_{1,i},y_{1,i},w_{1,i},h_{1,i},c_{1,i},s_{1,i};x_{2,i},y_{2,i},w_{2,i},h_{2,i},c_{2,i},s_{2,i};iouᵢ)}. Herein, in order to make the comparison meaningful, the bounding boxes with the confidence score under a pre-defined threshold tₛ are not considered. For example, tₛ could be 0.5, but the present disclosure is not limited thereto.

In order to distinguish the temporal complexity difference of various object scales, the frame-level MIOU can be measured at 3 spatial scales. In some embodiments, the paired bounding boxes can be classified into multiple groups. For example, the paired bounding boxes can be classified into a small group Pₛ where the object area is smaller than 32×32, a medium group Pₘ where the object area is smaller than 96×96 and larger than 32×32, and a large group Pₗ where the object area is larger than 96×96. In other words, the paired bounding boxes are classified into three groups noted as {Pₖ}, k=s,m,l for small, medium and large groups respectively. For every spatial group Pₖ, the bounding boxes are grouped based on object class indexes, noted as Pₖ={{(s_{1,k,i,j};s_{2,k,i,j};iou_{k,i,j})}ⱼ}, j=1, 2, . . . , ncₖ, where ncₖ is the number of object class indexes in Pₖ. The frame-level MIOU of group Pₖ can be defined as

$${M}_{f , k} = \frac{{Σ}_{j}^{n {c}_{k}} i o {u}_{k , j}}{{nc}_{k}} ,$$

where

$$io {u}_{k , j} = \frac{{Σ}_{i}^{{g}_{j}} 0.5 i o {u}_{k i j} ( {s}_{1 , k , i , j} + {s}_{2 , k , i , j} )}{{Σ}_{i}^{{g}_{j}} 0.5 ( {s}_{1 , k , i , j} + {s}_{2 , k , i , j} )} ,$$

indicating the IOU value of group k and class index j and gⱼ is the number of detected results for class index j. On this basis, the frame-level MIOU can be defined as M_{f}=(M_{f,k})=(M_{f,s},M_{f,m},M_{f,l}). Moreover, the detected bounding box number of Pₖ is nₖ,

$${n}_{k} = {Σ}_{j}^{n {c}_{k}} {Σ}_{i}^{{g}_{j}} 0.5 ( {s}_{1 , k , i , j} + {s}_{2 , k , i , j} ) ,$$

which can be defined in terms of confidence score. Specifically, the bounding box number for small, medium and large groups are represented with nₛ, nₘ, nₗ.

In some embodiments, the detected object class for the MIOU calculation can be different for various ultimate machine vision tasks. For example, all detected object classes can be considered in the MIOU calculation for an object detection task, while for an object tracking task, only the relevant moving object classes, such as person, car and bus, etc., are considered.

Regarding the sequence-level MIOU Mₛ, for every sequence, the sequence-level MIOU Mₛ can be calculated based on a batch of frames periodically. In some embodiments, only the first H frames of video sequence are calculated for simplification. The sequence-level MIOU Mₛ can be coding configuration dependent, in order to accommodate with the coding structure.

In some embodiments, at step 530, the decoder may calculate the sequence-level MIOU Mₛ according to a coding configuration for coding the video sequence. For example, in response to a random access (RA) coding configuration, the decoder may identify selected frames to calculate the frame-level MIOUs and calculate the sequence-level MIOU based on a weighted sum of the frame-level MIOUs, and the frame pairs correspond to multiple interval levels.

For example, for RA coding configuration, the minimal interval to calculate the frame-level MIOU is h, where H should be a power of 2 times of h. The frame-level MIOU between following frame pairs are calculated based on the following equation:

$$\{ ( {F}_{0} , {F}_{h} ) , … , ( {F}_{H - h} , {F}_{H} ) , ( {F}_{0} , {F}_{2 h} ) , … , ( {F}_{H - 2 h} , {F}_{H} ) , … , ( {F}_{0} , {F}_{\frac{H}{2}} ) , ( {F}_{\frac{H}{2}} , {F}_{H} ) , ( {F}_{0} , {F}_{H} ) \}$$

The frame pairs are selected with different intervals hₗ being h, 2h, . . . , H/2, H. The frame-level MIOU at interval hₗ level is defined based on the following equation:

$${M}_{f , {h}_{l}} = \frac{{Σ}_{l} ( {M}_{f , s} ( {F}_{0} , {F}_{{h}_{l}} ) , {M}_{f , m} ( {F}_{{h}_{l}} , {F}_{2 {h}_{l}} ) , … , {M}_{f , l} ( {F}_{H - {h}_{l}} , {F}_{H} ) )}{( H / {h}_{l} )} ,$$

where hₗ are h, 2h, . . . , H/2, H. The sequence level Mₛ is defined based on the weighted sum of {M_{f,h}_{ₗ})}. In some embodiments, for a larger interval hₗ, the weight is larger. In other words, for a first interval level of a first frame pair larger than a second interval level of a second frame pair, a first weight of a first frame-level MIOU for the first frame pair is greater than a second weight of a second frame-level MIOU for the second frame pair.

For example, for the resampling ratio being 2, H is 32 and h is 8. As such, {M_{f,h}_{ₗ})} is {M_{f,8}, M_{f,16}, M_{f,32}} and M_{f}=0.5M_{f,32}+0.3M_{f,16}+0.2M_{f,8}. For the resampling ratio being 4, H is 32 and h is 16. As such, {M_{f,h}_{ₗ})} is {M_{f,16}, M_{f,32}} and M_{f}=1.25 (0.5M_{f,32}+0.3M_{f,16}), 1.25 being a factor for normalization.

In addition, in response to a low delay (LD) coding configuration, the decoder may identify selected frames according to a fixed interval to calculate the frame-level MIOUs and calculate the sequence-level MIOU by calculating an average value of the frame-level MIOUs, in which each frame pair includes two neighboring selected frames.

For example, for LD coding configuration, the interval for calculating the frame-level MIOU is h, where H can also be a power of 2 times of h. The frame-level MIOU between frame pairs {(F₀, Fₕ), (Fₕ, F₂ₕ), . . . , (F_{H-h}, F_{H})} are calculated. Similarly, the sequence level Mₛ can be defined as the average of every frame-level MIOU. For example, for resampling ratio being 2, H is 32 and h is 8 and M_{f}=M_{f,8}. For resampling ratio being 4, H is 32 and h is 16 and M_{f}=M_{f,16}.

In some embodiments, for AI coding configuration, a smaller interval h for calculating the frame-level MIOU can be selected. The frame-level MIOU between frame pairs {(F₀, Fₕ), (Fₕ, F₂ₕ), . . . , (F_{H-h}, F_{H})} are calculated. Similarly, the sequence level Mₛ can be defined as the average of every frame-level MIOU. For example, for resampling ratio being 2, H is 32 and h is 2 and M_{f}=M_{f,2}. For resampling ratio being 4, H is 32 and h is 4 and M_{f}=M_{f,4}.

In some embodiments, an adaptive decision can be adopted. At step 540, the decoder obtains a decision metric according to the sequence-level MIOU to determine a resampling ratio and whether to perform a temporal resampling. In some embodiments, the decoder may obtain bounding box numbers for multiple groups corresponding to different object area sizes, obtain multiple sequence-level MIOUs for the groups, and obtain the decision metric based on the bounding box numbers and the sequence-level MIOUs for the groups.

As explained above, the paired bounding boxes can be classified into small, medium and large groups corresponding to different object area sizes. For each group, the bounding boxes are grouped based on object class indexes, and the detected bounding box numbers of the small, medium and large groups are nₛ, nₘ, nₗ. Sequence-level MIOUs M_{s,s}, M_{s,m}, M_{s,l} for small, medium, and large groups can be obtained accordingly.

For example, for sequence-level MIOU (M_{s,s}, M_{s,m}, M_{s,l}), the decision metric M_{D} can be defined as (nₛM_{s,s}+nₘM_{s,m}+nₗM_{s,l})/(nₛ+nₘ+nₗ). For the temporal resampling 2, if the decision metric M_{D,2} is larger or equal to 0.5, the temporal resampling is performed. Otherwise, no temporal resampling is performed. If the decision metric M_{D,2} is larger or equal to 0.5, the decision metric M_{D,4} for temporal resampling 4 is also calculated. If the decision metric M_{D,4} for temporal resampling 4 is larger or equal to 0.6, temporal resampling 4 is performed to replace temporal resampling 2.

Then, at step 550, the decoder may resample the one or more reconstructed frames based on the decision metric.

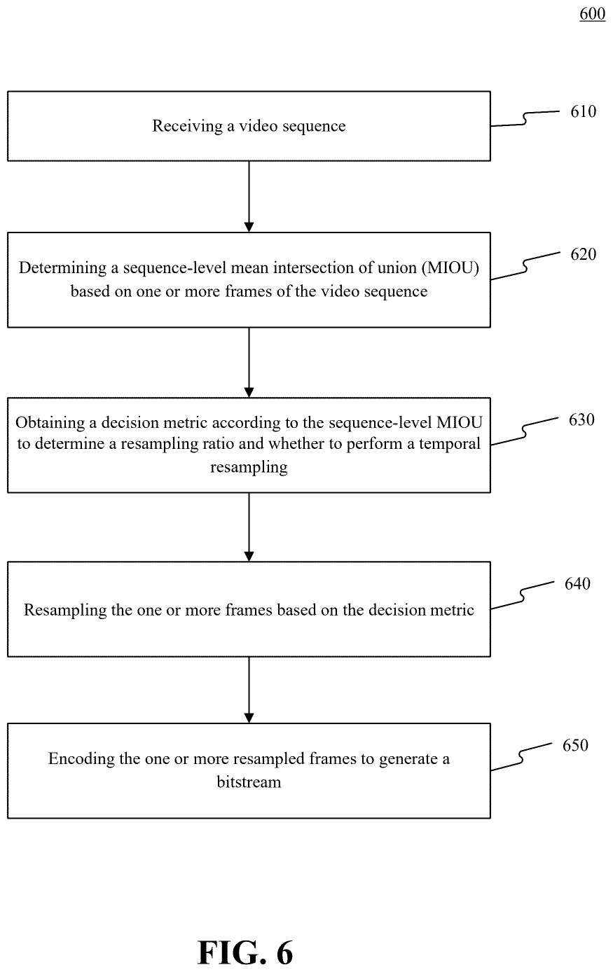

FIG. 6 is a flowchart for an example method 600 for encoding a video sequence into a bitstream, according to some embodiments of the present disclosure. The method 600 can be performed by an encoder to encode a video bitstream. For example, the encoder can be implemented as one or more software or hardware components of an apparatus (e.g., apparatus 400 in FIG. 4) for encoding the bitstream (e.g., bitstream 330 in FIG. 3) for reconstructing a video frame or a video sequence. For example, a processor (e.g., processor 402 in FIG. 4) can perform the method 600. As shown in FIG. 6, the method 600 includes the following steps 610-650. At step 610, the encoder receives a video sequence (e.g., input video 310 in FIG. 3).

At step 620, the encoder determines a sequence-level mean intersection of union (MIOU) based on one or more frames of the video sequence. As explained above, in some embodiments, the encoder may calculate frame-level MIOUs for frame pairs and calculate the sequence-level MIOU based on the frame-level MIOUs. Each frame pair includes two frames of the video sequence. In some embodiments, the encoder calculates the sequence-level MIOU according to a coding configuration for coding the video sequence.

For example, in response to a random access (RA) coding configuration, the encoder can identify selected frames to calculate the frame-level MIOUs, in which the frame pairs correspond to multiple interval levels. Then, the encoder can calculate the sequence-level MIOU based on a weighted sum of the frame-level MIOUs. In some embodiments, for a first interval level of a first frame pair larger than a second interval level of a second frame pair, a first weight of a first frame-level MIOU for the first frame pair is greater than a second weight of a second frame-level MIOU for the second frame pair.

In addition, in response to a low delay (LD) coding configuration, the encoder can identify selected frames according to a fixed interval to calculate the frame-level MIOUs, in which each frame pair includes two neighboring selected frames. Then, the encoder can calculate the sequence-level MIOU by calculating an average value of the plurality of frame-level MIOUs.

At step 630, the encoder obtains a decision metric according to the sequence-level MIOU to determine a resampling ratio and whether to perform a temporal resampling. In some embodiments, the encoder may obtain bounding box numbers for multiple groups corresponding to different object area sizes, obtain multiple sequence-level MIOUs for the groups, and obtain the decision metric based on the bounding box numbers and the sequence-level MIOUs for the groups. Details of the operations in steps 620 and 630 are similar or the same as those in steps 530 and 540 of the method 500 in FIG. 5 and thus are not repeated herein for the sake of brevity.

At step 640, the encoder resamples the one or more frames based on the decision metric. For example, the one or more frames can be rescaled by a temporal down-sampling model 324 as shown in FIG. 3.

At step 650, the encoder encodes the one or more resampled frames to generate a bitstream. For example, as shown in FIG. 3, the downsampled data {Fᵢ}_{D} can be compressed by the encoder 326 to generate the bitstream 330.

The embodiments described in the present disclosure can be freely combined.

In some embodiments, a non-transitory computer-readable storage medium storing a bitstream is also provided. The bitstream can be encoded and decoded according to the disclosed methods for implementing an analysis-based adaptive temporal resampling decision algorithm for machine vision.

In some embodiments, a method for storing a bitstream includes operations of: receiving a video sequence including one or more frames, encoding the video sequence, and signaling a bitstream generated based on the encoding. The video sequence is encoded by: determining a sequence-level mean intersection of union (MIOU) based on the one or more frames of the video sequence; obtaining a decision metric according to the sequence-level MIOU to determine whether to perform a temporal resampling and a resampling ratio; resampling the one or more frames based on the decision metric; and encoding the one or more resampled frames. Details of the operations of encoding the video sequence are similar or the same as those in the method 500 in FIG. 5 and the method 600 in FIG. 6, and thus are not repeated herein for the sake of brevity.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A method for decoding a bitstream associated with a video sequence, the method comprising:
decompressing a bitstream associated with a video sequence;
reconstructing one or more frames of the video sequence based on the decompressed bitstream;
determining a sequence-level mean intersection of union (MIOU) based on one or more reconstructed frames;
obtaining a decision metric according to the sequence-level MIOU to determine a resampling ratio and whether to perform a temporal resampling; and
resampling the one or more reconstructed frames based on the decision metric.

2. The method according to clause 1, further comprising:
calculating a plurality of frame-level MIOUs for a plurality of frame pairs, wherein each frame pair comprises two frames of the video sequence; and
calculating the sequence-level MIOU based on the plurality of frame-level MIOUs.

3. The method according to clause 2, further comprising:
calculating the sequence-level MIOU according to a coding configuration for coding the video sequence.

4. The method according to clause 2 or 3, further comprising:
in response to a random access (RA) coding configuration, identifying a plurality of selected frames to calculate the plurality of frame-level MIOUs, wherein the frame pairs correspond to a plurality of interval levels; and
calculating the sequence-level MIOU based on a weighted sum of the plurality of frame-level MIOUs.

5. The method according to clause 4, wherein for a first interval level of a first frame pair larger than a second interval level of a second frame pair, a first weight of a first frame-level MIOU for the first frame pair is greater than a second weight of a second frame-level MIOU for the second frame pair.

6. The method according to any of clauses 2-5, further comprising:
in response to a low delay (LD) coding configuration, identifying a plurality of selected frames according to a fixed interval to calculate the plurality of frame-level MIOUs, wherein each frame pair includes two neighboring selected frames; and
calculating the sequence-level MIOU by calculating an average value of the plurality of frame-level MIOUs.

7. The method according to any of clauses 1-6, further comprising:
obtaining a plurality of bounding box numbers for a plurality of groups corresponding to different object area sizes;
obtaining a plurality of sequence-level MIOUs for the plurality of groups; and
obtaining the decision metric based on the plurality of bounding box numbers and the plurality of sequence-level MIOUs for the plurality of groups.

8. A method for encoding a video sequence into a bitstream, the method comprising:
determining a sequence-level mean intersection of union (MIOU) based on one or more frames of the video sequence;
obtaining a decision metric according to the sequence-level MIOU to determine a resampling ratio and whether to perform a temporal resampling;
resampling the one or more frames based on the decision metric; and
encoding the one or more resampled frames to generate a bitstream.

9. The method according to clause 8, further comprising:
calculating a plurality of frame-level MIOUs for a plurality of frame pairs, wherein each frame pair comprises two frames of the video sequence; and
calculating the sequence-level MIOU based on the plurality of frame-level MIOUs.

10. The method according to clause 9, further comprising:
calculating the sequence-level MIOU according to a coding configuration for coding the video sequence.

11. The method according to clause 9 or 10, further comprising:
in response to a random access (RA) coding configuration, identifying a plurality of selected frames to calculate the plurality of frame-level MIOUs, wherein the frame pairs correspond to a plurality of interval levels; and
calculating the sequence-level MIOU based on a weighted sum of the plurality of frame-level MIOUs.

12. The method according to clause 11, wherein for a first interval level of a first frame pair larger than a second interval level of a second frame pair, a first weight of a first frame-level MIOU for the first frame pair is greater than a second weight of a second frame-level MIOU for the second frame pair.

13. The method according to any of clauses 9-12, further comprising:
in response to a low delay (LD) coding configuration, identifying a plurality of selected frames according to a fixed interval to calculate the plurality of frame-level MIOUs, wherein each frame pair includes two neighboring selected frames; and
calculating the sequence-level MIOU by calculating an average value of the plurality of frame-level MIOUs.

14. The method according to any of clauses 8-13, further comprising:
obtaining a plurality of bounding box numbers for a plurality of groups corresponding to different object area sizes;
obtaining a plurality of sequence-level MIOUs for the plurality of groups; and
obtaining the decision metric based on the plurality of bounding box numbers and the plurality of sequence-level MIOUs for the plurality of groups.

15. A method for transmitting a bitstream, comprising:
receiving a video sequence including one or more frames;
encoding the video sequence by:
   determining a sequence-level mean intersection of union (MIOU) based on the one or more frames of the video sequence;
   obtaining a decision metric according to the sequence-level MIOU to determine a resampling ratio and whether to perform a temporal resampling;
   resampling the one or more frames based on the decision metric; and
encoding the one or more resampled frames; and
signaling a bitstream generated based on the encoding.

16. The method according to clause 15, wherein the encoding the video sequence further comprises:
calculating a plurality of frame-level MIOUs for a plurality of frame pairs, wherein each frame pair comprises two frames of the video sequence; and
calculating the sequence-level MIOU based on the plurality of frame-level MIOUs.

17. The method according to clause 16, wherein the encoding the video sequence further comprises:
calculating the sequence-level MIOU according to a coding configuration for coding the video sequence.

18. The method according to clause 16 or 17, wherein the encoding the video sequence further comprises:
in response to a random access (RA) coding configuration, identifying a plurality of selected frames to calculate the plurality of frame-level MIOUs, wherein the frame pairs correspond to a plurality of interval levels; and
calculating the sequence-level MIOU based on a weighted sum of the plurality of frame-level MIOUs.

19. The method according to clause 18, wherein for a first interval level of a first frame pair larger than a second interval level of a second frame pair, a first weight of a first frame-level MIOU for the first frame pair is greater than a second weight of a second frame-level MIOU for the second frame pair.

20. The method according to any of clauses 16-19, wherein the encoding the video sequence further comprises:
in response to a low delay (LD) coding configuration, identifying a plurality of selected frames according to a fixed interval to calculate the plurality of frame-level MIOUs, wherein each frame pair includes two neighboring selected frames; and
calculating the sequence-level MIOU by calculating an average value of the plurality of frame-level MIOUs.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for decoding a bitstream associated with a video sequence, the method comprising:
decompressing a bitstream associated with a video sequence;
reconstructing one or more frames of the video sequence based on the decompressed bitstream;
determining a sequence-level mean intersection of union (MIOU) based on one or more reconstructed frames;
obtaining a decision metric according to the sequence-level MIOU to determine a resampling ratio and whether to perform a temporal resampling; and
resampling the one or more reconstructed frames based on the decision metric.

2. The method according to claim 1, further comprising:
calculating a plurality of frame-level MIOUs for a plurality of frame pairs, wherein each frame pair comprises two frames of the video sequence; and
calculating the sequence-level MIOU based on the plurality of frame-level MIOUs.

3. The method according to claim 2, further comprising:
calculating the sequence-level MIOU according to a coding configuration for coding the video sequence.

4. The method according to claim 2, further comprising:
in response to a random access (RA) coding configuration, identifying a plurality of selected frames to calculate the plurality of frame-level MIOUs, wherein the frame pairs correspond to a plurality of interval levels; and
calculating the sequence-level MIOU based on a weighted sum of the plurality of frame-level MIOUs.

5. The method according to claim 4, wherein for a first interval level of a first frame pair larger than a second interval level of a second frame pair, a first weight of a first frame-level MIOU for the first frame pair is greater than a second weight of a second frame-level MIOU for the second frame pair.

6. The method according to claim 2, further comprising:
in response to a low delay (LD) coding configuration, identifying a plurality of selected frames according to a fixed interval to calculate the plurality of frame-level MIOUs, wherein each frame pair includes two neighboring selected frames; and
calculating the sequence-level MIOU by calculating an average value of the plurality of frame-level MIOUs.

7. The method according to claim 1, further comprising:
obtaining a plurality of bounding box numbers for a plurality of groups corresponding to different object area sizes;
obtaining a plurality of sequence-level MIOUs for the plurality of groups; and
obtaining the decision metric based on the plurality of bounding box numbers and the plurality of sequence-level MIOUs for the plurality of groups.

8. A method for encoding a video sequence into a bitstream, the method comprising:
determining a sequence-level mean intersection of union (MIOU) based on one or more frames of the video sequence;
obtaining a decision metric according to the sequence-level MIOU to determine a resampling ratio and whether to perform a temporal resampling;
resampling the one or more frames based on the decision metric; and
encoding the one or more resampled frames to generate a bitstream.

9. The method according to claim 8, further comprising:
calculating a plurality of frame-level MIOUs for a plurality of frame pairs, wherein each frame pair comprises two frames of the video sequence; and
calculating the sequence-level MIOU based on the plurality of frame-level MIOUs.

10. The method according to claim 9, further comprising:
calculating the sequence-level MIOU according to a coding configuration for coding the video sequence.

11. The method according to claim 9, further comprising:
in response to a random access (RA) coding configuration, identifying a plurality of selected frames to calculate the plurality of frame-level MIOUs, wherein the frame pairs correspond to a plurality of interval levels; and
calculating the sequence-level MIOU based on a weighted sum of the plurality of frame-level MIOUs.

12. The method according to claim 11, wherein for a first interval level of a first frame pair larger than a second interval level of a second frame pair, a first weight of a first frame-level MIOU for the first frame pair is greater than a second weight of a second frame-level MIOU for the second frame pair.

13. The method according to claim 9, further comprising:
in response to a low delay (LD) coding configuration, identifying a plurality of selected frames according to a fixed interval to calculate the plurality of frame-level MIOUs, wherein each frame pair includes two neighboring selected frames; and
calculating the sequence-level MIOU by calculating an average value of the plurality of frame-level MIOUs.

14. The method according to claim 8, further comprising:
obtaining a plurality of bounding box numbers for a plurality of groups corresponding to different object area sizes;
obtaining a plurality of sequence-level MIOUs for the plurality of groups; and
obtaining the decision metric based on the plurality of bounding box numbers and the plurality of sequence-level MIOUs for the plurality of groups.

15. A method for transmitting a bitstream, comprising:
receiving a video sequence including one or more frames;
encoding the video sequence by:
determining a sequence-level mean intersection of union (MIOU) based on the one or more frames of the video sequence;
obtaining a decision metric according to the sequence-level MIOU to determine a resampling ratio and whether to perform a temporal resampling;
resampling the one or more frames based on the decision metric; and
encoding the one or more resampled frames; and
signaling a bitstream generated based on the encoding.

16. The method according to claim 15, wherein the encoding the video sequence further comprises:
calculating a plurality of frame-level MIOUs for a plurality of frame pairs, wherein each frame pair comprises two frames of the video sequence; and
calculating the sequence-level MIOU based on the plurality of frame-level MIOUs.

17. The method according to claim 16, wherein the encoding the video sequence further comprises:
calculating the sequence-level MIOU according to a coding configuration for coding the video sequence.

18. The method according to claim 16, wherein the encoding the video sequence further comprises:
in response to a random access (RA) coding configuration, identifying a plurality of selected frames to calculate the plurality of frame-level MIOUs, wherein the frame pairs correspond to a plurality of interval levels; and
calculating the sequence-level MIOU based on a weighted sum of the plurality of frame-level MIOUs.

19. The method according to claim 18, wherein for a first interval level of a first frame pair larger than a second interval level of a second frame pair, a first weight of a first frame-level MIOU for the first frame pair is greater than a second weight of a second frame-level MIOU for the second frame pair.

20. The method according to claim 16, wherein the encoding the video sequence further comprises:
in response to a low delay (LD) coding configuration, identifying a plurality of selected frames according to a fixed interval to calculate the plurality of frame-level MIOUs, wherein each frame pair includes two neighboring selected frames; and
calculating the sequence-level MIOU by calculating an average value of the plurality of frame-level MIOUs.
